(19) United States
(12) Patent Application Publication
(10) Pub. No.: US 2014/0064584 A1
(43) Pub. Date: Mar. 6, 2014

(54) DETERMINING A PLANAR EXAMINATION AREA

(71) Applicant: SIEMENS AKTIENGESELLSCHAFT, Munich (DE)

(72) Inventor: Sebastian SCHMIDT, Weisendorf (DE)

(73) Assignee: SIEMENS AKTIENGESELLSCHAFT, Munich (DE)

(21) Appl. No.: 14/017,390

(22) Filed: Sep. 4, 2013

(30) Foreign Application Priority Data
Sep. 6, 2012 (DE) 102012215825.1

(51) Int. Cl. G06T 7/00

(52) U.S. Cl. CPC G06T 7/0014
USPC 382/130

(57) ABSTRACT

A method is disclosed for determining a planar examination area based on the recording of a first and also a second three-dimensional medical image. In at least one embodiment, the two images each map the least one common examination area, wherein the second image was recorded via a radiopharmaceutical and via a different modality from the first image. The first image is segmented so that the examination area in the segmented first image is represented by a two-dimensional surface, through which a determination of a distance between the image elements of the second image and the image elements of the segmented first image forming the surface is made possible by use of a common coordinate system of the two images. Finally image elements of the second image are assigned to the image elements of the segmented, first image forming the surface, depending on a criterion relating to the distance.

### PRIORITY STATEMENT

The present application hereby claims priority under 35 U.S.C. §119 to German patent application number DE 102012215825.1 filed Sep. 6, 2012, the entire contents of which are hereby incorporated herein by reference.

### FIELD

At least one embodiment of the invention generally relates to a method and/or to a system for determining a planar examination area. At least one embodiment of the invention further generally relates to a computer program product and to a computer-readable medium.

### BACKGROUND

Imaging devices such as a Magnetic Resonance Tomograph (MRT) or a Computed Tomograph (CT) offer outstanding resolution but only a low specific contrast for the presentation of tumors. These methods are only suitable to a degree, especially for the presentation of planar tumors along serous membranes, for example the peritoneum or the pleura. A Positron Emission Tomograph (PET), by using radiopharmaceuticals which collect in tumors and then decay into positrons, achieves a high specific contrast. However the local resolution of a PET is inferior to that of an MRT and CT. When planar tumors along serous membranes are presented by means of a PET a partial volume effect also results: at locations at which the peritoneum has multiple folds, for example with intestinal loops, the signal appears stronger, but appears weaker at other points however. The images are thus difficult to interpret. This results in the problem of incorrect therapy decisions being made on the basis of incorrect information.

A system for segmenting a target organ tumor from an image is known from DE 10 2006 047 373 A1. The system contains a background model former, wherein the background model former uses an intensity distribution estimation of the voxels in an organ area in an image to form a background model. The system also contains a foreground model former, wherein the background model former uses an intensity distribution estimation of the voxels in a target organ tumor to form a first foreground model. The system also contains a tumor area localizer, wherein the tumor area localizer uses the background model and the first foreground model in order to segment the target organ tumor to obtain a first segmentation result.

### SUMMARY

At least one embodiment of the invention is directed to improving the reliability in the examination of a planar examination area, especially a tumor along serous membrane.

A method, a computer program product and a system are disclosed.

Features, advantages or alternate embodiments mentioned here are likewise to be transferred to the other claimed subject matters and vice versa. In other words the claims (which are directed to a system for example) can also be further developed with the features which are described or claimed in connection with a method. The corresponding functional features of the method are embodied in such cases by corresponding objective modules.

An embodiment of the method is for determining a planar examination area based on the recording of a first and also a second three-dimensional medical image, wherein the first and the second image each map at least one identical examination area, wherein the second image has been recorded by way of a radiopharmaceutical and by way of different modality from the first image. An embodiment of the invention is based on the idea of segmenting the first image so that the examination area in the segmented first image is represented by a two-dimensional surface, through which a determination of the distance between the image elements of the second image as well as the image elements of the segmented first image forming the surface are made possible by way of a common coordinate system of the first image and of the second image. Finally image elements of the second image are assigned to the image elements of the segmented first image forming the surface, depending on a criterion related to the distance between the image elements of the second image and the image elements of the segmented first image forming the surface. This combines the advantages of a specific modality detecting the decay processes of the radiopharmaceutical with a complementary modality so that the reliability is improved in the determination of a planar examination area, especially of a tumor along serous membranes.

A further embodiment comprises a computer program product with a computer program able to the called up in the internal memory of a computer for executing the method for determining a planar examination area, so that the steps of the method can be executed in a rapid, identically repeatable and robust manner.

A further embodiment comprises a computer-readable medium on which the computer program product is stored for execution.

In at least one embodiment, a system is disclosed for determining a planar examination area, comprising:
Imaging unit, designed for recording a first three-dimensional medical image by means of a first modality and also designed for recording a second three-dimensional medical image by means of a radiopharmaceutical and also a second modality, wherein the first and the second modality differ, wherein the first and the second image each map an image of at least one identical examination area,
Segmentation unit, designed for segmenting a first image, so that the examination area is represented by a two-dimensional surface,
Determination unit, designed for determining a distance between the image elements of the segmented first image forming the surface and the image elements of the second image by means of registration, and
Assignment unit, designed for assigning image elements of the second image to the image elements of the segmented first image forming the surface, depending on a criterion relating to the distance between the image elements of the second image and the image elements of the segmented first image forming the surface.

### BRIEF DESCRIPTION OF THE DRAWINGS

The invention is described and illustrated in greater detail below with reference to the exemplary embodiments shown in the figures, in which:

FIG. 1 shows a flow diagram of a method for determining a planar examination area,

FIG. 2 shows a system for determining a planar examination area,

FIG. 3 shows a pictorial example of the determination of a planar examination area, and

FIG. 4 shows an expanded system for determining a planar examination area.

### DETAILED DESCRIPTION OF THE EXAMPLE EMBODIMENTS

The present invention will be further described in detail in conjunction with the accompanying drawings and embodiments. It should be understood that the particular embodiments described herein are only used to illustrate the present invention but not to limit the present invention.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

Specific structural and functional details disclosed herein are merely representative for purposes of describing example embodiments of the present invention. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

An embodiment of the method is for determining a planar examination area based on the recording of a first and also a second three-dimensional medical image, wherein the first and the second image each map at least one identical examination area, wherein the second image has been recorded by way of a radiopharmaceutical and by way of different modality from the first image. An embodiment of the invention is based on the idea of segmenting the first image so that the examination area in the segmented first image is represented by a two-dimensional surface, through which a determination of the distance between the image elements of the second image as well as the image elements of the segmented first image forming the surface are made possible by way of a common coordinate system of the first image and of the second image. Finally image elements of the second image are assigned to the image elements of the segmented first image forming the surface, depending on a criterion related to the distance between the image elements of the second image and the image elements of the segmented first image forming the surface. This combines the advantages of a specific modality detecting the decay processes of the radiopharmaceutical with a complementary modality so that the reliability is improved in the determination of a planar examination area, especially of a tumor along serous membranes.

In a further embodiment, the examination area involves a tumor along a serous membrane. This has the advantage that tumors can be represented as images by way of a radiopharmaceutical with especially high specific contrast.

In a further embodiment, the modality for recording the second image involves Positron Emission Tomography (PET), which exhibits an especially high signal sensitivity.

In a further embodiment, the modality for recording the second image involves Single Photon Emission Computed Tomography (SPECT) representing a good variant for obtaining high specific contrast by means of a radiopharmaceutical.

In a further embodiment, the modality for recording the first image involves Magnetic Resonance Tomography (MRT) having a particularly high spatial resolution.

In a further embodiment, the modality for recording the first image involves Computed Tomography (CT) likewise having a particularly high spatial resolution.

In a further embodiment, the first image and the second image have been recorded simultaneously or directly one after the other with the same medical device, so that the two images already have a common coordinate system during the reconstruction.

In a further embodiment, the criterion is the smallest distance between the image elements of the second image and the image elements of the segmented first image forming the surface, which makes it possible to identify the information of the second image with that of the first image in an especially simple form.

A further embodiment comprises the presentation of the assignment in the form of a graphical output, comprising a color and/or brightness encoding of the surface in accordance with the intensity of the image elements of the second image assigned to the respective image elements of the surface, through which the linkage of the information of the two images is presented in an especially easy-to-interpret manner.

A further embodiment comprises a computer program product with a computer program able to the called up in the internal memory of a computer for executing the method for determining a planar examination area, so that the steps of the method can be executed in a rapid, identically repeatable and robust manner.

A further embodiment comprises a computer-readable medium on which the computer program product is stored for execution.

The advantageous embodiments of the method for determining a planar examination area can especially be carried out with the following system or with a system that is designed for carrying out the embodiments and is based on the following system:

In at least one embodiment, a system is disclosed for determining a planar examination area, comprising:
Imaging unit, designed for recording a first three-dimensional medical image by means of a first modality and also designed for recording a second three-dimensional medical image by means of a radiopharmaceutical and also a second modality, wherein the first and the second modality differ, wherein the first and the second image each map an image of at least one identical examination area,
Segmentation unit, designed for segmenting a first image, so that the examination area is represented by a two-dimensional surface,
Determination unit, designed for determining a distance between the image elements of the segmented first image forming the surface and the image elements of the second image by means of registration, and
Assignment unit, designed for assigning image elements of the second image to the image elements of the segmented first image forming the surface, depending on a criterion relating to the distance between the image elements of the second image and the image elements of the segmented first image forming the surface.

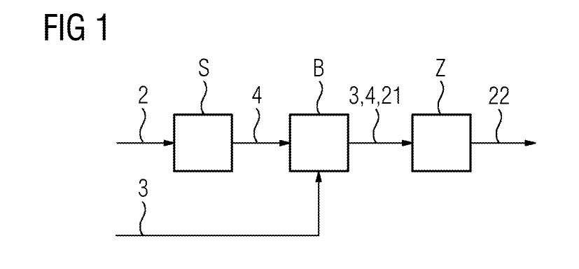

FIG. 1 shows a flow diagram of a method for determination B of a planar examination area 1. Such an examination area 1 can basically be any planar-shaped region of the body of a patient 7. In particular the method specified here is suitable for determination B of tumors 27 along a serous membrane. The method is based on the recording of a first image 2 and also a second image 3, which involve a three-dimensional medical image in each case which each map an identical examination area 1 and wherein the second image 3 has been recorded by means of a radiopharmaceutical and by means of a different modality from the first image 2.

A medical image involves an image recorded by a medical imaging device 19 for medical purposes, predominantly for diagnosis. The terms “medical image” and “image” are used synonymously below. Furthermore, within the meaning of the present application, images can especially be preprocessed, i.e. filtered, images or images reconstructed into slice images. A three-dimensional image involves a first dataset which represents a volume. A three-dimensional image can especially be present in the form of a stack of two-dimensional (slice) images.

“Identical” means here that the same examination area 1 within the meaning of a medical-functional unit, e.g. a specific organ, is imaged in the same patient 7. “Identical” within the meaning of the application also includes examination areas 1, which are influenced in their function or other characteristics between the recording of the first image 2 and of the second image 3, e.g. by a medicament or a radiopharmaceutical.

For the method described below it is especially useful for the first image 2 to have been recorded by way of the modality of an MRT or CT. This is because these techniques provide a high spatial resolution. However it is difficult to generate a specific contrast with them, e.g. between a tumor 27 along a serous membrane and surrounding tissue. Furthermore contrast media can be used to facilitate the later segmentation S of the examination area 1 in the first image 2, recorded by means of an MRT or CT. Such a contrast medium is for example a suspension containing barium sulfate and is used to present esophagus, stomach and intestine. In addition contrast media containing iodine are widely used.

For a recording of the first image 2 by way of an MRT, sequences and methods can be used in particular to increase the image quality and thus facilitate this subsequent segmentation S, e.g. Chemical Shift Imaging, Dixon method, in-phase-opposed-phase.

Furthermore it is advantageous to record the second image 3 by way of the modality of a PET or SPECT. In these techniques a radiopharmaceutical, also known as a tracer, is administered to the patient 7, typically it is injected into them in the form of a solution. Examples for radiopharmaceuticals are 18F-Fluorodeoxyglucose or [11C]Cholin. The decay products of the radiopharmaceutical are detected in the form of high-energy photons. Specific radiopharmaceuticals have the property of accumulating in specific tissue types, e.g. [11C]Cholin accumulates in tumors 27, since tumor cells, through their faster reproduction, have an increased need for Cholin. The second image 3 can thus supply highly-specific information, however the resolution of such specific modalities such as PET and SPECT is restricted. It is therefore worth attempting to combine the high spatial resolution of modalities such as MRT or CT with the specific information of modalities such as PET or SPECT.

In the first step of an embodiment of the method the first image 2 is segmented, so that the examination area 1 is represented in the segmented, first image 4 by a two-dimensional surface 5. The segmentation S is undertaken for example by a threshold value method or by a region-oriented method such as Region Growing or Region Splitting or with the aid of edge extraction. Such a surface 5 is typically embodied in such cases as a contour in a three-dimensional space. Furthermore a segmentation S of the second image is also useful in order to reduce the computing outlay of the subsequent steps.

Furthermore, the distance between the image elements of the second image 3 and the image elements of the segmented first image 1 forming the surface 5 are determined by means of the registration R. The image elements can involve voxels or pixels. The segmentation S of the first image 2 (and if necessary the segmentation S of the second image 3) does not significantly influence the distance search, since the segmentation S only leads to a selection of the image elements. Therefore the distance sought is able to be easily calculated in the common coordinate system, the result is the distance data 21. If the first image 2 and the second image 3 are recorded simultaneously or directly after one another by the same medical device 19, the images typically have a common coordinate system through their reconstruction.

The assignment Z of image elements of the second image 3 to the image elements of the segmented, first image 4 forming the surface 5, depending on a criterion relating to the distance between the image elements of the second image 3 and the image elements of the segmented first image 4 forming the surface 5 now makes it possible to combine the advantages of a high-resolution modality with those of a highly-specific modality. Such a criterion is the smallest distance between the image elements of the second image 3 and the image elements of the segmented first image 4 forming the surface 5. The result of the assignment Z is the output data 22 which now combines the information of the first image 2 and also the second image 3 with one another, and does so in such a way that the examination area 1 visualized in the second image 3 can be clearly assigned to an anatomical structure which surrounds the examination area 1 or encloses the examination area 1. This makes it possible for example to determine the precise extent of a planar tumor 27 along serous membranes and thereby to select the best form of therapy. If for example the extent of such a tumor 27 is underestimated or incorrectly localized, this can lead to incorrect operation planning.

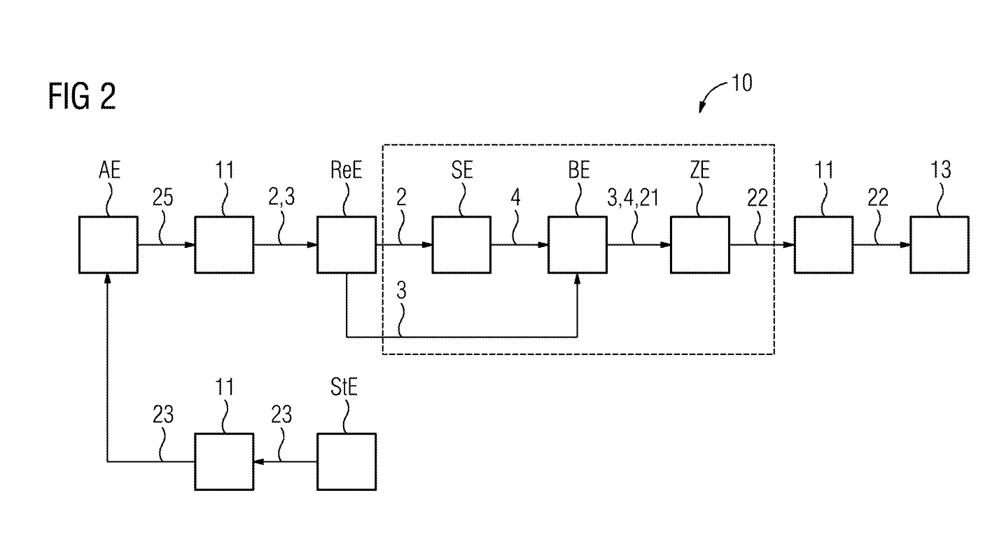

FIG. 2 shows a system for determination B of a planar examination area 1. The system is embodied in this case as an apparatus. The system depicted is especially embodied for carrying out the method described in FIG. 1. The control unit StE is embodied together with the recording unit AE for recording raw data 25. In such cases the control unit StE passes control values 23 to the recording unit AE, which e.g. specify the x-ray tube voltage in the case of an x-ray tube as radiation source 8. Raw data 25 involves data which is detected directly by the radiation detector 9 and is not suitable for presentation D, e.g. voltage values or electron densities. The reconstruction unit ReE is embodied for reconstruction of the first image 2 as well as the second image 3 from the raw data 25. The segmentation unit SE is embodied for segmentation S of images, especially for segmentation S of the first image 2 and of the second image 3. The determination unit BE is embodied to perform the determination B and the assignment unit ZE is embodied to perform the assignment Z. The segmentation unit SE, the determination unit BE and the assignment unit ZE are combined to form an image processing unit 10. Such an image processing unit 10 can be embodied as a computer program, but the individual units can also be embodied as individual computer program products or as hardware. The interfaces 11 involve generally-known hardware or software interfaces 11, e.g. the hardware interfaces 11 PCI bus, USB or Firewire.

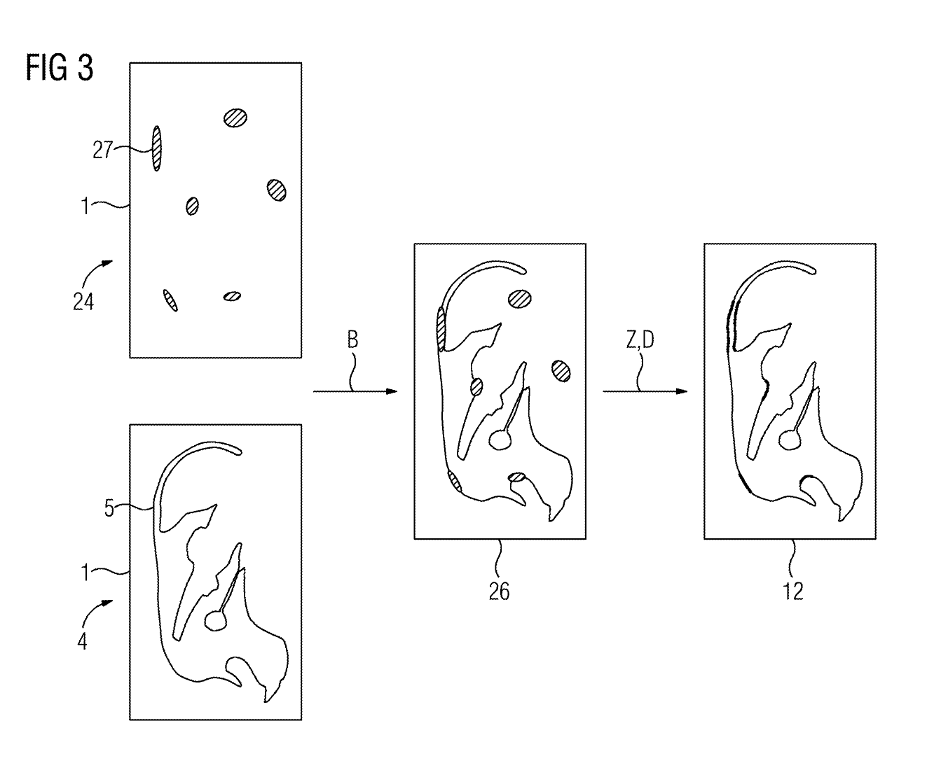

FIG. 3 shows a pictorial example of the determination B of a planar examination area 1. A segmented, first image 4 is produced by the segmentation S of the first image 2. In this case the examination area 1, which is shown here as an already segmented surface 5, involves the peritoneum of a patient 7. The segmented, first image 4 shown here only shows a two-dimensional view, i.e. a sectional image to the complete dataset of the segmented first image 4. The examination area 1 is segmented as a surface 5 extended in a three-dimensional space. In this sense the segmented second image 24 also involves a slice image which is based on a three-dimensional dataset.

The structures able to be detected in the second, segmented image 24 involve a representation of different tumors 27 in the stomach area of the patient 7. The tumors 27 have been recorded with the aid of a radiopharmaceutical. The segmented first image 4 and the segmented second image 24 are already registered. Therefore the determination B of the distance between the image elements of the segmented, second image 24 and also the image elements forming the surface 5 of the segmented first image 4 can be undertaken by means of the registration R.

The intermediate image 26 combines the information of the segmented first image 4, the segmented second image 24 and also the determination B. Furthermore there is an assignment Z of image elements of the second, segmented image 24 to the image elements of the segmented, first image 4 forming the surface 5, depending on a criterion relating to the distance between the image elements of the second, segmented image 3 and the image elements of the segmented, first image 4 forming the surface 5. The assignment Z is then displayed D in the form of a graphical output 12 on the output unit 13.

In accordance with the intensity of the image elements of the second, segmented image 24 assigned to the respective image elements of the surface 5, a color and/or brightness encoding of the surface 5 can be undertaken during the display D. Here the bright areas of the respective image elements of the second, segmented image 24 assigned to the respective image elements of the surface 5 are shown bold. Color coding can include for example of allocating a value of the hue scale to each intensity. The Standardized Uptake Value (SUV), which describes the nuclide administration independently of time and weighting, can serve as a basis for color and/or brightness encoding. Furthermore the display D can also comprise a three-dimensional graphical output 12.

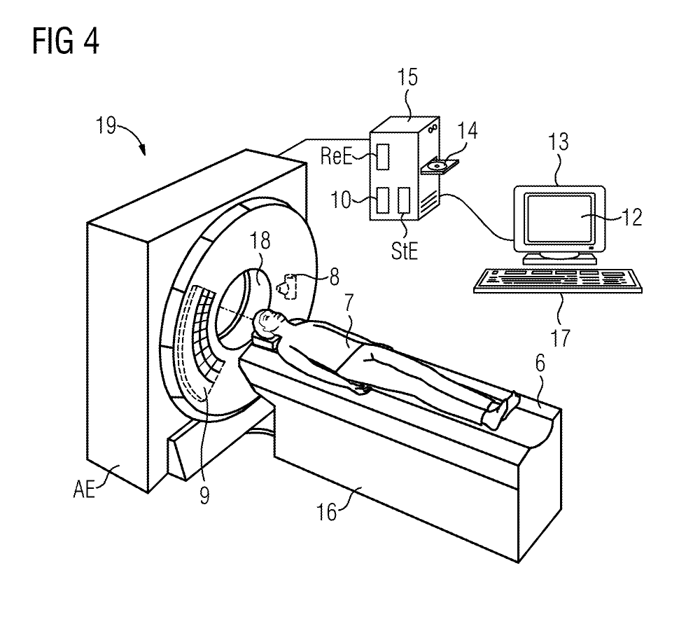

FIG. 4 shows an expanded system for determination B of a planar examination area 1, comprising a medical device 19 in the form of a combined CT-PET with a recording unit AE having a radiation source 8 and a radiation detector 9. The radiation emitter 8 for a CT typically involves an x-ray tube. The radiation detector 9 for a CT-PET typically involves a row or flat-panel detector, but it can also be embodied as a scintillator counter or CCD camera. In particular two different radiation detectors 9 can be built into the recording unit AE for the different modalities (CT, PET). The medical device 19 can for example involve a combined MRT-PET, CT-SPECT or MRT-SPECT. With an MRT the recording unit AE has at least one RF coil. An individual RF coil can in this case be embodied both as a radiation emitter 8 and also as a radiation detector 9 for the MRT. The RF coil can especially involve a local coil, e.g. a head or knee coil.

During the recording of a medical image the patient 7 lies on a patient couch 6, which is connected to a couch base 16 so that it bears the patient couch 6 with the patient 7. The patient couch 6 moves the patient 7 in a recording direction through the opening 18 of the recording unit AE. During this movement an image of the examination area 1 of the patient 7 is created.

The recordings of the recording unit AE are sent for processing and/or display to a computer 15. In the embodiment shown here the computer 15 has both a control unit StE for controlling the recording unit AE and also an image processing unit 10 as well is a reconstruction unit ReE, which are each described in greater detail in FIG. 2. Furthermore the computer 15 and also the recording unit AE have interfaces 11 so that data such as a raw data 25 or the control values 23 can be transmitted in each case to other units. The control unit StE, the image processing unit 10 and also the reconstruction unit ReE can be embodied both in the form of hardware and also software. Typically these units are embodied in the form of a computer program product, which can be called up in the internal memory of the computer 15.

Both the control unit StE and also the image processing unit 10 or individual units of the image processing unit 10 can run on different computers 15. E.g. the image processing unit 10 can run on the server, while the control unit StE is embodied as part of the medical device 19.

Typically the computer program product has been loaded with the aid of a computer-readable medium 21 into the memory of the computer 15. The computer-readable medium 14 can for example involve a DVD, a USB stick, a hard disk or a diskette.

The data processing unit 15 is connected to an output unit 13 and also an input unit 17. The output unit 13 can for example involve one (or more) LCD, plasma or OLED screen(s). The output 12 on the output unit 13 serves to display the original image data of the first image 2 as well is the second image 3 and also all further-processed data. The output 12 is also suitable for displaying a graphical user interface for selecting a specific form of display for the data. The input unit 17 involves a keyboard, a mouse, a touchscreen or also a microphone for voice input for example.

Although the invention has been illustrated and described in greater detail on the basis of the preferred exemplary embodiments, the invention is not limited by the disclosed examples and other variations can be derived herefrom by the person skilled in the art without departing from the scope of protection of the invention.

In particular method steps can be carried out in a sequence other than that specified.

What is claimed is:

1. A method for determining a planar examination area on the basis of a first and second three-dimensional medical image, the first and second image each mapping at least one common examination area, the second image being recorded via a radiopharmaceutical and via a different modality from the first image, the method comprising:
segmenting the first image, so that the examination area is segmented in the segmented first image by a two-dimensional surface;
determining the distance between image elements of the second image and image elements of the segmented first image forming the surface via a common coordinate system of the first image and of the second image; and
assigning image elements of the second image for the image elements of the segmented first image forming the surface, depending on a criterion relating to a distance between the image elements of the second image from the image elements of the segmented first image forming the surface.

2. The method of claim 1, wherein the examination area involves a tumor along a serous membrane.

3. The method of claim 1, wherein the modality for recording the second image involves a Positron Emission Tomograph.

4. The method of claim 1, wherein the modality for recording the second image involves a Single Photon Emission Computed Tomograph.

5. The method of claim 1, wherein the modality for recording the first image involves a Magnetic Resonance Tomograph.

6. The method of claim 1, wherein the modality for recording the first image involves a Computed Tomograph.

7. The method of claim 1, wherein the first image and the second image were recorded simultaneously or directly one after the other with the same medical device.

8. The method of claim 1, wherein the criterion is a relatively smallest distance between the image elements of the second image and the image elements of the segmented first image forming the surface.

9. The method of claim 1, further comprising:
displaying the assignment in the form of a graphical output, including at least one of a color and brightness encoding of the surface corresponding to the intensity of the image elements of the second image assigned to the respective image elements of the surface.

10. A computer program product, able to be called up in an internal memory of a computer, comprising a computer program for, when executed, carrying out the method of claim 1.

11. A computer-readable medium, in which the computer program product as claimed in claim 10 is stored for execution.

12. A system for determining a planar examination area, comprising:
an imaging unit, configured to record a first three-dimensional medical image via a first modality and further configured to record a second three-dimensional medical image via a radiopharmaceutical and a second modality, the first and the second modality differing from one another, and the first and the second image each recording an image of at least one common examination area;
a segmentation unit, configured to segment a first image, so that the examination area is represented by a two-dimensional surface;
a determination unit, configured to determine a distance between the image elements of the segmented first image forming the surface and the image elements of the second image via a common coordinate system of the first image and of the second image; and
an assignment unit, configured to assign image elements of the second image to the image elements of the segmented first image forming the surface, depending on a criterion relating to a distance between the image elements of the second image and the image elements of the segmented first image forming the surface.

13. The system of claim 12, designed for performing the method of claim 1.

14. The method of claim 2, wherein the modality for recording the second image involves a Positron Emission Tomograph.

15. The method of claim 2, wherein the modality for recording the second image involves a Single Photon Emission Computed Tomograph.

16. The method of claim 2, wherein the modality for recording the first image involves a Magnetic Resonance Tomograph.

17. The method of claim 2, wherein the modality for recording the first image involves a Computed Tomograph.

18. The method of claim 3, wherein the modality for recording the first image involves a Magnetic Resonance Tomograph.

19. The method of claim 3, wherein the modality for recording the first image involves a Computed Tomograph.

20. The method of claim 4, wherein the modality for recording the first image involves a Magnetic Resonance Tomograph.

21. The method of claim 4, wherein the modality for recording the first image involves a Computed Tomograph.

22. A computer readable medium including program segments for, when executed on a computer device, causing the computer device to implement the method of claim 1.

23. The system of claim 12, further comprising:
a display, configured to display the assignment in the form of a graphical output, including at least one of a color and brightness encoding of the surface corresponding to the intensity of the image elements of the second image assigned to the respective image elements of the surface.
